(19) United States
(12) Patent Application Publication
(10) Pub. No.: US 2005/0111908 A1
(43) Pub. Date: May 26, 2005

(54) Tie rod end

(76) Inventors: Steve J. Green, Clarkston, MI (US); Brian A. Urbach, Rochester Hills, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/721,306

(22) Filed: Nov. 24, 2003

(51) Int. Cl. F16D 1/12

(52) U.S. Cl. 403/132; 403/135

(57) ABSTRACT

A ball joint (12) includes a housing (18) having at least one opening (26) and an inner chamber (28). The ball joint (12) further includes a ball stud (40) disposed in the chamber (28) of the housing (18) and an outer surface (44A). A resilient member (46) is fixedly attached to the outer surface (44A) of said ball stud (40).

### BACKGROUND OF THE INVENTION

This invention relates in general to a tie rod end for use in a vehicle steering system and in particular to an improved ball joint for such tie rod end.

Ball joints are commonly used in motor vehicle steering systems and in motor vehicle suspension systems. Tie rod ends for motor vehicle steering systems typically comprise a ball joint. Such ball joints provide an articulated connection between two relatively movable parts. In a vehicle steering system for a four wheel steer vehicle, ball joints are commonly adapted to be connected to a steering arm of each of a left and a right rear wheel knuckle. Typically, a ball joint for a motor vehicle steering system includes a ball stud with a spherical ball end and a socket member with a spherical socket. A bearing member in the socket receives the ball end and supports the ball end for rotational and pivotal movement.

In the steering gears for vehicles having four wheel steering, it is known to provide a spring to return the rear wheels to a normal or a straight ahead condition when the steering wheel is released or in the event of a vehicle electrical failure. However, such steering gears can be undesirably bulky and expensive.

It would therefore be desirable to provide an improved structure for returning the rear wheels to a normal or a straight ahead condition when the steering wheel is released or in the event of a vehicle electrical failure.

### SUMMARY OF THE INVENTION

The present invention relates to a ball joint. In one embodiment, the ball joint includes a housing having at least one opening and an inner chamber. The ball joint further includes a ball stud disposed in the chamber of the housing and an outer surface. A resilient member is fixedly attached to the outer surface of said ball stud.

Other advantages of this invention will become apparent to those skilled in the art from the following detailed description of the invention, when read in light of the accompanying drawings.

### BRIEF DESCRIPTION OF THE DRAWINGS

FIG. 1 is a view, partially in section, of a tie rod end including a first embodiment of a ball joint constructed in accordance with the present invention.

FIG. 2 is an exploded view of the ball joint illustrated in FIG. 1, showing the ball joint prior to assembly.

FIG. 3 is a view, partially in section, of a second embodiment of a ball joint constructed in accordance with the present invention.

### DETAILED DESCRIPTION OF THE INVENTION

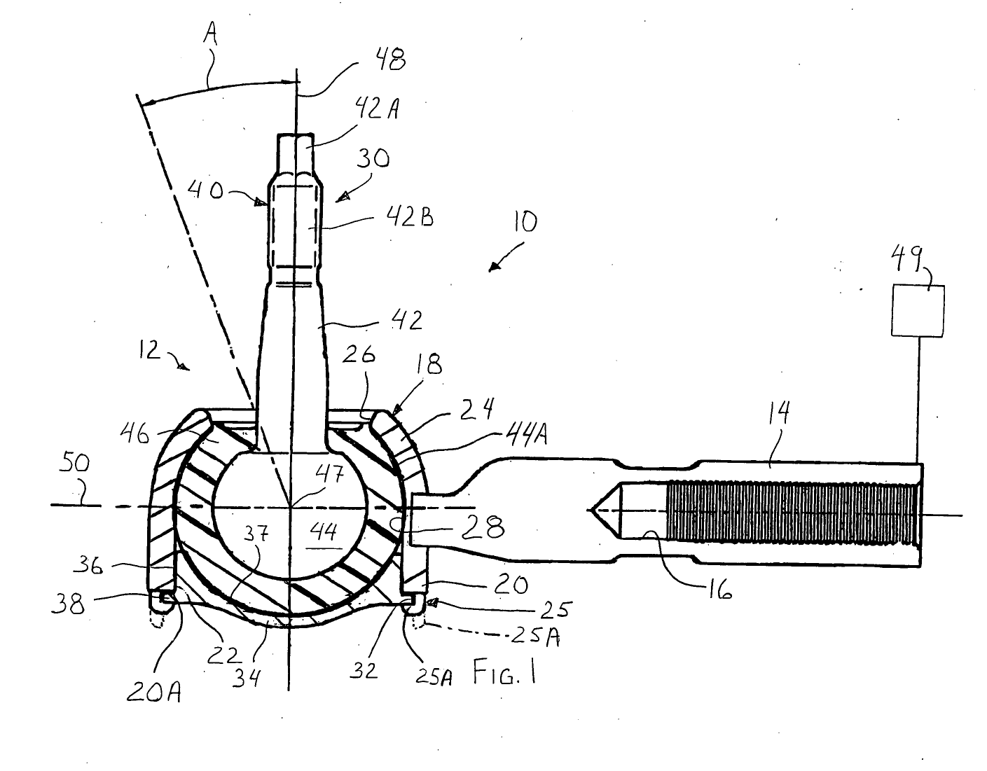

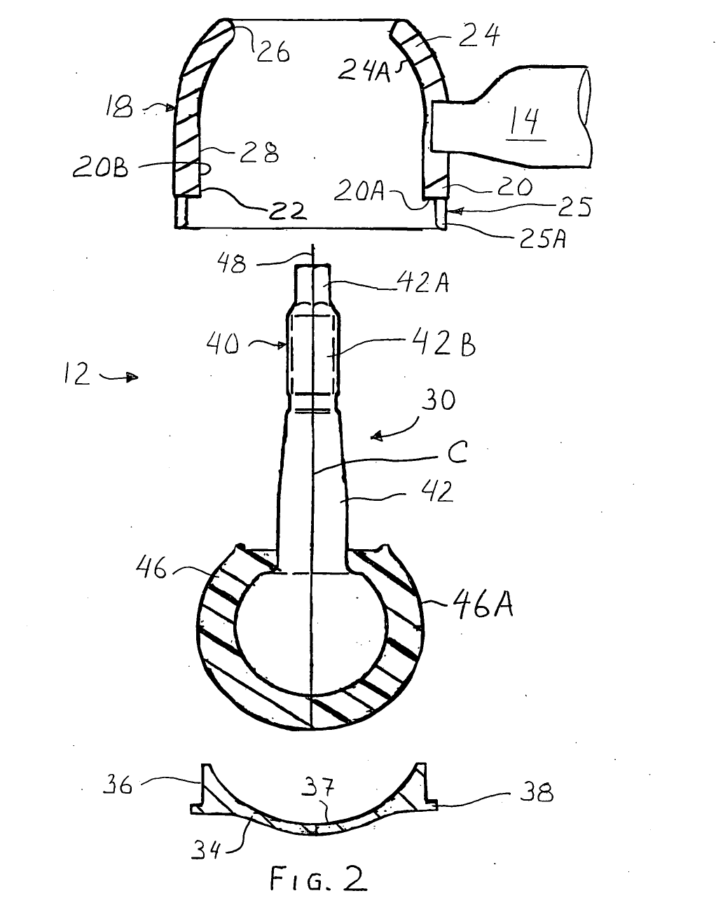

Referring now to FIGS. 1 and 2, there is illustrated a tie rod end assembly, indicated generally at 10, including a first embodiment of a ball joint 12 constructed in accordance with the present invention. A tie rod end embodying the present invention may be used in a variety of applications. The tie rod end assembly 10 of the present invention is embodied as a portion of a vehicle steering linkage (not shown) used to turn the steerable rear wheels (not shown) of a vehicle.

The vehicle steering linkage can include a pair of tie rod end assemblies 10 adapted to be connected to a steering arm (not shown) of each of a left and a right rear wheel knuckle (not shown). Each of the left and right tie rod end assemblies 10 is identically constructed and therefore only one will be described herein in detail. The tie rod end assembly 10 includes a stem 14. The stem 14 can be made of any desired material, such as metal. For example, the stem 14 can be made of aluminum or forged from steel. The stem 14 is generally cylindrical in shape and includes an internal bore 16. The bore 16 is provided with internal threads 16A along a portion thereof. The threads 16A of the stem 14 are adapted to receive an externally threaded portion of a tie rod (not shown). Alternatively, other methods can be used to couple the stem 14 and the tie rod together if so desired.

The stem 14 is attached to a rigid metal housing 18 of the ball joint 12 by any desired method, such as by welding. The housing 18 includes a generally cylindrical side wall portion 20 defining a first opening 22, and a generally hemispherical side wall portion 24 defining a second opening 26. The end of the cylindrical side wall portion 20 at the first opening 22 includes a longitudinally extending flange portion 25 and a radially inward extending engagement surface 20A. The flange portion 25 includes a remote end 25A shown in a first or unassembled position in FIG. 2 and a second or assembled position in FIG. 1. When in the assembled position as shown in FIG. 1, the flange portion 25 defines a circumferentially extending groove 32 on the housing 18.

The housing 18 defines a housing chamber 28 within which is located a resilient ball stud assembly 30. The housing 18 is made by a suitable process from a suitable material. For example, the housing 18 can be cold formed or screw machined from normalized SAE grade 1038 steel. Alternately, the housing 18 can be formed from other materials, such as for example, other metals and non-metals.

A generally annular plug or cap 34 is inserted within the first opening 22 to close the first opening 22, and thereby retain the resilient ball stud assembly 30 within the housing chamber 28. The cap 34 preferably includes a generally cylindrical outer wall 36 for engaging an inner surface 20B of the cylindrical side wall portion 20 of the housing 18. An inner surface 37 of the cap 34 is preferably hemispherical in shape for engaging a portion of a ball member 46 of the resilient ball stud assembly 30. The outer wall 36 of the cap 34 has a circumferentially and outwardly extending flange 38. The flange 38 is disposed within the groove 32, in a manner as will be described below. The cap 34 is preferably stamped from low-carbon SAE grade 1008 or 1010 steel. Alternately, the cap 34 can be formed from other materials, such as for example, other metals and non-metals.

The resilient ball stud assembly 30 includes a ball stud 40 and a resilient ball member 46. The ball stud 40 includes a generally cylindrical shank 42 and a spherical ball portion 44 having an outer surface 44A. In the embodiment illustrated, the shank 42 includes a distal end portion 42A having a hexagonal cross section and an externally threaded portion 42B for receiving a nut (not shown). The shank 42 extends through the second opening 26 of the housing 18. The resilient ball member 46 covers the ball portion 44 of the ball stud 40. The ball stud 40 is preferably cold headed or screw machined and then carbonized. The ball stud 40 is made of SAE grade 8115M or 8615 steel which is available from LTV Steel. Alternately, the ball stud 40 can be formed from other materials, such as for example, other metals and non-metals.

The resilient ball member 46 is preferably fixedly attached or bonded to the outer surface of the ball portion 44. To accomplish this, the resilient ball member 46 is preferably formed about an outer surface of the ball portion 44 under sufficient heat and pressure so as to bond the material, such as rubber, of the resilient ball member 46 to the ball portion 44. The resilient ball member 46 can be bonded to the ball portion 44 by any suitable method, such as by injection molding. If desired, an adhesive can be applied to the outer surface of the ball portion 44 prior to injection molding to provide a chemical bond between the ball portion 44 and the resilient ball member 46. Any suitable adhesive can be used, such, as for example resorcinal-formaldehyde-latex (RFL) in an aqueous solution, which is available from Lord Chemical or Dupont. Alternately, any other suitable adhesive can be used. The resilient ball member 46 is preferably made of neoprene or natural rubber. Alternately, the resilient ball member 46 can be formed from other materials, such as for example, other elastomers and other resilient materials.

The housing 18 supports the resilient ball stud assembly 30 for limited rotation and pivoting movement about a center of oscillation 47. As used herein, the center of oscillation is the intersection of a longitudinal axis 48 and a transverse axis 50 of the ball stud 40. The center of oscillation 47 is coincident with a center of the spherical ball portion 44 of the ball stud 40.

The resilient member 46 allows the resilient ball stud assembly 30 to oscillate about the center of oscillation 47 such that a center C of the shank 42, shown in FIG. 2, can pivot to a position no greater than a position defined by an oscillation angle A, as shown in FIG. 1. Such oscillation occurs when a force is applied to the stem 14, such as when the vehicle wheels are turned upon turning of the vehicle steering wheel by the vehicle operator. The resilient member 46 further allows for limited torsional or rotational movement of the ball stud 40. When such oscillation ends, the resilient member 46 then exerts a restoring or centering force which causes the resilient ball stud assembly 30 to return to a normal or centered position, as shown in FIG. 1. The oscillation angle A is defined as an angle of movement of the shank 42 as measured from the longitudinal axis 48. Preferably, the resilient ball member 46 has a desired hardness such that the oscillation angle A is within the range of from about 0 degrees to about 40 degrees. More preferably, the angle A is about 20 degrees. It will be understood that the resilient member 46 of the resilient ball stud assembly 30 can be constructed so as to have any desired hardness, and thereby to have any desired centering force.

To assemble the first embodiment of the ball joint 12 shown in FIGS. 1 and 2, the housing 18 is preferably first formed to include the generally hemispherical side wall portion 24 and the generally cylindrical side wall portion 20, wherein the remote end 25A of the flange portion 25 is in the unassembled position as best shown in FIG. 2.

The resilient ball stud assembly 30 is then moved axially upward (as viewed in the Figures). The resilient ball stud assembly 30 is moved into the chamber 28 through the first opening 22 until the shank 42 extends through the second opening 26 and the ball member 46 fully contacts a hemispherical inner surface 24A of the hemispherical side wall portion 24. The cap 34 is then inserted into the opening 22 such that the cylindrical outer wall 36 frictionally engages the inner surface 20B of the cylindrical side wall portion 20 of the housing 18 and the flange 38 engages the engagement surface 20A. A force is then applied to the remote end 25A of the flange portion 25 so as to move the remote end 25A of the flange portion 25 from the unassembled position shown in FIG. 2 (and shown in phantom in FIG. 1), to the assembled position shown in FIG. 1. Such a force can be applied by any desired method, such as by spin forming or by crimping.

Preferably, a sufficient force is applied to the remote end 25A of the flange portion 25 so that the plug 34 is operative to force and compress the resilient member 46 upwardly within the chamber 28 such an outer surface 46A of the resilient member 46 will not slide or otherwise move relative to the inner surfaces 20B and 24A of the housing 18 and an inner surface 37 of the cap 34 during normal steering operation. If desired, an adhesive can be applied to the inner surfaces 20B and 24A of the housing 18 prior to inserting the resilient ball stud assembly 30 to provide a chemical bond between the outer surface 46A of the ball member 46 and the inner surfaces 20B and 24A of the housing 18 and the surface 37 of the cap 34. Any suitable adhesive can be used, such as, for example resorcinal-formaldehyde-latex (RFL) in an aqueous solution. Alternately, any other suitable adhesive can be used. If desired, a seal (not shown) can be disposed within the second opening 26 for closing and sealing the opening 26. Alternatively, other suitable methods can be used to couple the ball member 46 to the housing 18 and/or the cap 34 to prevent relative movement therebetween if so desired.

In the embodiment illustrated in FIGS. 1 and 2, the cap 34 is secured or joined to the housing 18 by a method such as spin forming or crimping. Alternately, the cap 34 could be secured to the housing 18 by any other desired methods if so desired. [should discuss 2^{nd} embodiment, then discuss advantages since they apply to both embodiments of the invention]

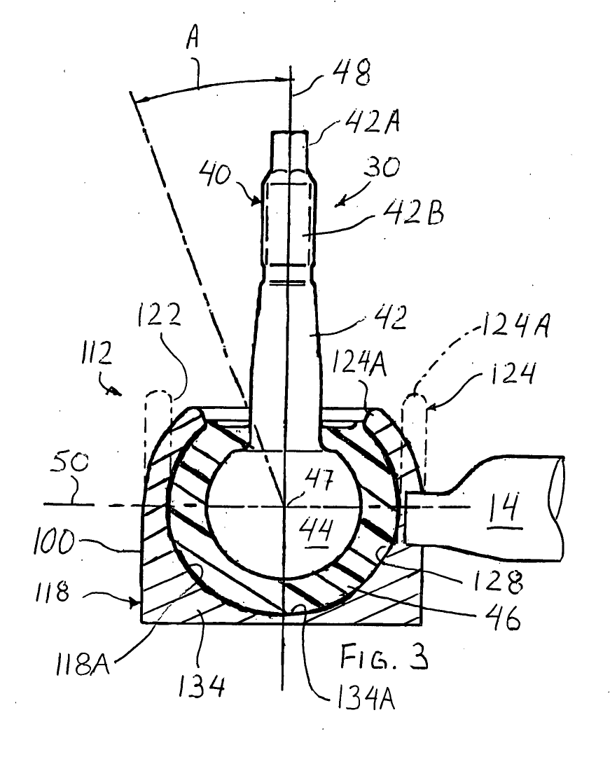

Referring now to FIG. 3 and using like reference numbers to indicate corresponding parts, there is illustrated a second embodiment of the ball joint, indicated generally at 112, constructed in accordance with the present invention. The ball joint 112 is substantially identical to the ball joint 12, except that the ball joint 112 includes an alternate embodiment of a housing 118.

As shown in the embodiment illustrated in FIG. 3, the housing 118 includes a body 100 having an end wall 134 defining a first end or cap portion and a second end 124. The second end 124 includes a remote end 124A, which is shown in solid in FIG. 3 in an assembled position and in phantom in an unassembled position. The structure and function of the other components of the ball joint 112 are otherwise identical to the ball joint 12, and will not be further described herein.

To assemble the embodiment of the ball joint 112 shown in FIG. 3, the housing 118 is preferably first formed to include the generally cylindrical body 100 including the remote end 124A as shown in phantom. The resilient ball stud assembly 30 (which includes the ball stud 40 and the resilient member 46), is then moved axially downward (as viewed in FIG. 3) into a housing chamber 128 through a first opening 122 until the resilient ball stud assembly 30 fully engages a hemispherical inner surface 134A of the cap portion 134. A force is then applied to the remote end 124A of the second end 124 of the housing 118 so as to deform the remote end 124A from the unassembled position shown in phantom to the assembled position shown in solid. Such a force can be applied by any desired method, such as by spin forming or by crimping. As described above regarding the first embodiment of the ball joint 12, a sufficient force is applied to the remote end 124A of the second end 124 so as to force and compress the resilient member 46 downwardly within the chamber 128 such the outer surface 46A of the resilient member 46 will not slide or otherwise move relative to an inner surface 11 8A of the housing 118 during normal steering operation. If desired, an adhesive can be applied to the entire inner surface 11 8A of the housing 118 or selected areas thereof prior to inserting the resilient ball stud assembly 30 to provide a chemical bond between the outer surface 46A of the ball member 46 and the inner surface 118A of the housing 118. Any suitable adhesive can be used, such as, for example resorcinal-formaldehyde-latex (RFL) in an aqueous solution. Alternately, any other suitable adhesive can be used.

One advantage of the present invention is that the resilient ball stud assembly 30 functions as a biasing member or spring for exerting a centering force on the ball joint 12. The centering force causes the steerable vehicle rear wheels to return to a normal or a straight ahead condition. The resilient ball stud assembly 30 returns the steerable vehicle rear wheels to the straight ahead condition when a force, such as the force applied by the turning of the vehicle steering wheel, is released or during a vehicle electrical failure. As described above, the resilient ball stud assembly 30 can freely oscillate to the angle A within the range of from about 0 degrees to about 40 degrees. The centering force, as determined by a predetermined hardness of the resilient member 46 then causes the resilient ball stud assembly 30 to return to the normal position, as viewed in FIG. 1, when the steering wheel is released by the vehicle operator, or when a vehicle power failure occurs.

Another advantage of the resilient ball stud assembly 30 is that a corresponding rear wheel steering gear can be provided without a return or centering spring, thereby reducing the size and cost of such a steering gear. Because the resilient ball stud assembly 30 of the present invention functions as a return spring as described above, no such return spring is necessary in the rear wheel steering gear of the vehicle.

The principle and mode of operation of this invention have been described in its preferred embodiments. However, it should be noted that this invention may be practiced otherwise than as specifically illustrated and described without departing from its scope.

1. A ball joint comprising:
a housing having at least one opening and an inner chamber;
a ball stud disposed in said chamber of said housing and having an outer surface; and
a resilient member fixedly attached to said outer surface of said ball stud.

2. The ball joint according to claim 1, wherein said ball stud has a first axis and second axis transverse to the first axis, an intersection of the first axis and the second axis defining a center of oscillation, wherein said ball stud is normally centered on the center of oscillation.

3. The ball joint according to claim 2, wherein when a first force is applied to said ball stud, said ball stud is caused to oscillate about the center of oscillation within a predetermined angle relative to the normally centered position, and wherein the predetermined angle is within the range of from about 0 degrees to about 40 degrees.

4. The ball joint according to claim 1, wherein said resilient member is formed of a material having a predetermined hardness to thereby apply a restoring force to maintain or return said ball stud to the normally centered position.

5. The ball joint according to claim 1, wherein said housing includes a pair of openings.

6. The ball joint according to claim 5, further including a cap carried by said housing about one of said pair of openings to thereby seal said one of said pair of openings and retain said ball stud within said inner chamber of said housing.

7. The ball joint according to claim 6, wherein said cap is secured to said housing by deforming a portion of said housing about said cap.

8. The ball joint according to claim 1, wherein said ball stud includes a ball portion and a shaft extending outwardly from said ball portion through said at least one opening.

9. The ball joint according to claim 1, wherein said inner chamber is generally spherical shaped and an outer surface of said resilient member is generally spherical shaped.

10. The ball joint according to claim 1, wherein said resilient ball member is fixedly attached to the outer surface of said ball stud with an adhesive.

11. The ball joint according to claim 1, wherein an outer surface of said resilient ball member frictionally engages said inner chamber of said housing.

12. The ball joint according to claim 1, wherein said resilient member is formed from one of rubber and neoprene.

13. A ball joint for a vehicle having steering wheel, said ball joint comprising:
a housing having at least one opening and an inner chamber;
a ball stud disposed in said chamber of said housing and having an outer surface; and
a resilient member fixedly attached to said outer surface of said ball stud, wherein said ball stud has a first axis and second axis transverse to the first axis, an intersection of the first axis and the second axis defining a center of oscillation, wherein said ball stud is normally centered on the center of oscillation, and wherein said resilient ball member is formed of a material having a predetermined hardness to thereby apply a restoring force to maintain or restore said ball stud to the normally centered position.

14. The ball joint according to claim 13, wherein when a first force is applied to said ball stud by turning of a vehicle steering wheel, said ball stud is caused to oscillate about the center of oscillation within a predetermined angle relative to the normally centered position, and wherein the predetermined angle is within the range of from about 0 degrees to about 40 degrees.

15. The ball joint according to claim 13, wherein said housing includes a pair of openings.

16. The ball joint according to claim 15, further including a cap carried by said housing about one of said pair of openings to thereby seal said one of said pair of openings and retain said ball stud within said inner chamber of said housing.

17. The ball joint according to claim 16, wherein said cap is secured to said housing by deforming a portion of said housing about said cap.

18. The ball joint according to claim 13, wherein said ball stud includes a ball portion and a shaft extending outwardly from said ball portion through said at least one opening.

19. The ball joint according to claim 13, wherein said inner chamber is generally spherical shaped and an outer surface of said resilient member is generally spherical shaped.

20. The ball joint according to claim 13, wherein said resilient ball member is fixedly attached to the outer surface of said ball stud with an adhesive.

21. The ball joint according to claim 13, wherein an outer surface of said resilient ball member frictionally engages said inner chamber of said housing.

22. The ball joint according to claim 13, wherein said resilient member is formed from one of rubber and neoprene.

23. A tie rod end adapted for use in a vehicle having a steering wheel for controlling steerable wheels, said tie rod end comprising:
a housing having at least one opening and an inner chamber;
a stem extending outwardly from said housing;
a ball stud disposed in said chamber of said housing and having an outer surface, wherein said ball stud has a first axis and second axis transverse to the first axis, an intersection of the first axis and the second axis defining a center of oscillation, and wherein said ball stud is normally centered on the center of oscillation; and
a resilient member fixedly attached to said outer surface of said ball stud, wherein said resilient ball member is formed of a material having a predetermined hardness to thereby apply a restoring force to maintain or restore said ball stud to the normally centered position, and wherein when a first force is applied to said ball stud by turning of a vehicle steering wheel, said ball stud is caused to oscillate about the center of oscillation within a predetermined angle relative to the normally centered position, and wherein the predetermined angle is within the range of from about 0 degrees to about 40 degrees.

24. The tie rod end according to claim 23, wherein said housing includes a pair of openings.

25. The tie rod end according to claim 24, further including a cap carried by said housing about one of said pair of openings to thereby seal said one of said pair of openings and retain said ball stud within said inner chamber of said housing, wherein said cap is secured to said housing by deforming a portion of said housing about said cap.

26. The tie rod end according to claim 23, wherein said resilient ball member is fixedly attached to the outer surface of said ball stud with an adhesive.
